(19) United States
(12) Patent Application Publication
(10) Pub. No.: US 2018/0260809 A1
(43) Pub. Date: Sep. 13, 2018

(54) ADAPTIVE DIGITIZED CARDS

(71) Applicant: MasterCard International Incorporated, Purchase, NY (US)

(72) Inventors: Kerry Tryon, Valley Cottage, NY (US); John Baker, Brooklyn, NY (US); Gary Adler, Teaneck, NJ (US); Nigel John Raynor, Haslemere (GB)

(21) Appl. No.: 15/454,042

(22) Filed: Mar. 9, 2017

(51) Int. Cl. G06Q 20/34; G06Q 20/36; G06Q 20/10; G06Q 20/24

(52) U.S. Cl. CPC G06Q 20/351; G06Q 20/36; G06Q 30/0226; G06Q 20/24; G06Q 20/10

(57) ABSTRACT

A digitized card data structure is stored in association with a digital card environment. The digitized card data structure corresponds to a card issued to a card holder. The digitized card data structure has a component for providing output to the card holder. Under a first condition the component provides a first output and under a second condition, the component provides a second output different from the first output.

### BACKGROUND

For a considerable period of time, payment cards have been issued to allow individuals to access credit accounts or deposit accounts or other sources of funding to settle purchase transactions. When a card is issued, it represents a card account that was opened for the card holder by the account issuer.

More recently, the concept of a “digital wallet” has been developed. According to two main aspects of this concept, (a) an individual's digital wallet may be stored on a remote server computer operated by a wallet service provider (WSP); and/or (b) a mobile wallet application may run on a mobile device such as a smartphone. In either case, one or more credit or debit card accounts or the like may be associated with—and accessible via—the resulting digital wallet. To install a particular card account in the account holder's digital wallet, a digitized version of the card (i.e., digitized account data, including a data that represents an account number or payment token, and other data typically stored in a payment card) may be provisioned to the WSP or mobile device.

The digital wallet concept is not limited to payment accounts, but rather may also encompass other forms of identification or access, including digitized transit system entry cards, digitized customer loyalty account cards, digitized library cards, driver's licenses, passports, etc.

The present inventors have recognized opportunities to increase the convenience and usefulness of digitized cards held in digital wallets and other environments.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a high-level block diagram that illustrates a digitized card deployment system according to some embodiments.

FIGS. 2, 3 and 4 are block diagrams of respective computer systems that may be components of the system illustrated in FIG. 1.

FIG. 5 is a simplified block diagram of a typical mobile device that may be used in connection with the system of FIG. 1.

FIG. 5A is a schematic representation of some software aspects of the mobile device shown in FIG. 5.

FIGS. 6, 7 and 8 are flow charts that illustrate processes that may be performed in accordance with aspects of the present disclosure in connection with the system of FIG. 1.

FIG. 9 is a schematic illustration of a card image that may be presented to a user in connection with the process of FIG. 8.

FIG. 10 is another process that may be performed in accordance with aspects of the present disclosure in connection with the system of FIG. 1.

### DETAILED DESCRIPTION

In general, and for the purpose of introducing concepts of embodiments of the present disclosure, digital components may be created that extend the capabilities of digitized cards. The digital components may be authored and curated, and then distributed to account issuers, digitization services providers or other entities that issue digitized cards. The digital components may be incorporated into the digitized cards to provide functionality so that the components/cards exhibit adaptive behavior that changes the behavior of the card/component depending on conditions encountered during use or deployment of the digitized cards.

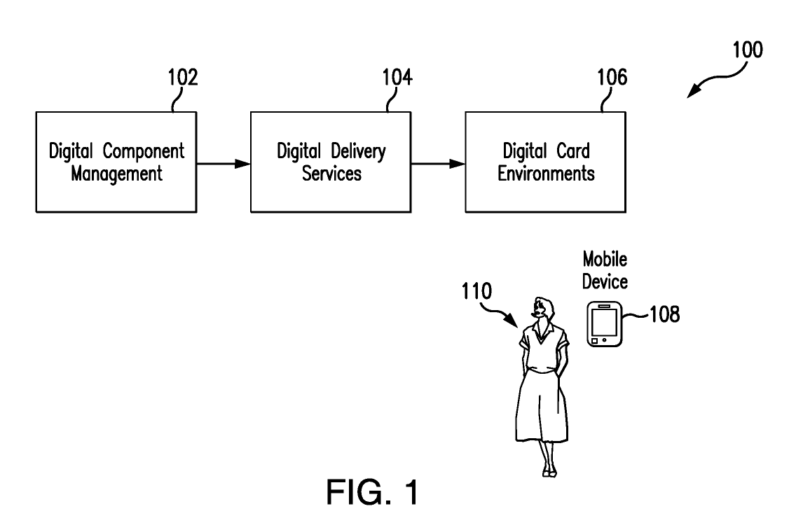

FIG. 1 is a high-level block diagram that illustrates a digitized card deployment system 100 according to some embodiments.

The digitized card deployment system 100 may include a digital component management system 102 and one or more digital delivery services 104. Generally speaking, adaptive digital components (and perhaps non-adaptive digital components as well) may be assembled, managed and stored in the digital component management system 102. Adaptive (and/or non-adaptive) digital components may be downloaded to the digital delivery services 104. At the digital delivery services 104, the digital components may be incorporated in digitized cards to be provisioned or deployed to digital card environments 106. One example digital card environment is separately shown in FIG. 1 as a mobile device 108, carried and operated by a user 110.

Although further details and/or examples of the digital component management system 102, the digital delivery services 104, the digital card environments 106 and the mobile device 108 will be described below, further background regarding the digitized card deployment system 100 and components thereof will now be described.

Digitized cards may have many aspects. These may include, for example, a card image background, an issuer logo, a card product brand name, a payment network logo or other branding, a co-branding image element, account information specific to the particular card (e.g., payment account number or payment token, etc.). Those who are skilled in the art are familiar with other aspects and/or associated data that pertain to typical digitized cards.

According to teachings of this disclosure, digital components may be generated and managed to be available to card issuers for incorporation in digitized cards. The digital components may have adaptive features that change or exhibit appropriate or useful behaviors to allow the digitized cards in which they are incorporated to adapt to changing conditions, take advantage of opportunities, provide guidance to users, etc. The adaptive digital components may be available to be used in place of conventional static digitized card components or may represent features and/or potential behaviors not conventionally provided in digitized cards. The adaptive digital components may include one or more multimedia elements, as well as scripts/widgets that control/exhibit the behaviors of the digital components. The multimedia elements may include, but not be limited to, still images, video, animated images, sound (spoken words, music, alert/update audible signals, etc.) and/or vibration.

The digital component management system 102 may be available as one or more of (a) a resource to serve authors of digital components, (b) a storage facility for digital components; and (c) a publisher of digital components. The authors may be, for example, associated with, employed by, or retained by entities such as an operator of a payment network, an issuer of card products, a creator of digital resources, a merchant, a wallet service provider, etc.

In some embodiments, the digital component management system 102 may be accessible to individual card holders (such as user 110) to allow the card holders to personalize adaptive and/or non-adaptive digital components to be incorporated in digitized cards to be issued to the card holders.

With incorporation of adaptive digital components in a digitized card, the digitized card may be capable of enhanced communication with the card holder, including modes of communication to and with the user that are not available in conventional digitized cards. Adaptive components incorporated into digitized cards may enable the digitized cards to respond to sound and/or voice triggers, to change multimedia elements in response to current conditions and to provide visual effects such as 3-D and/or video effects and/or other multimedia effects to enhance the user experience. Adaptive behaviors that may be incorporated in digitized cards—via digital components—may include location-based behaviors, time/event based behaviors, business logic, and behaviors that reflect machine intelligence.

The types of digitized cards that may incorporate adaptive digital components may include payment cards, transit access cards, library cards, and customer loyalty account cards among other types of cards.

The digital delivery services 104 that construct and deliver the digitized cards described herein may include card issuers (e.g., financial institutions, government agencies), card provisioning services (e.g., “MDES”—Mastercard Digital Enablement Service, offered by Mastercard International Incorporated, the assignee hereof), wallet service providers, merchants, etc. The digital card environments 106 to which the digitized cards are provisioned, and in which they are used, may include mobile devices (e.g., item 108, FIG. 1), wallet service providers and their server computers, merchants that employ card-on-file practices; and digital service providers.

To discuss the subject matter of FIG. 1 more generally, it should be understood that in most cases, blocks labeled therein with names/descriptions of entities should also be understood to represent computer systems operated by or for such entities.

It should also be understood that, for at least some types of participants in or components of the digitized card deployment system 100, there may be a considerable or even a very large number of participants or constituent devices of those types in practical embodiments of the digitized card deployment system 100.

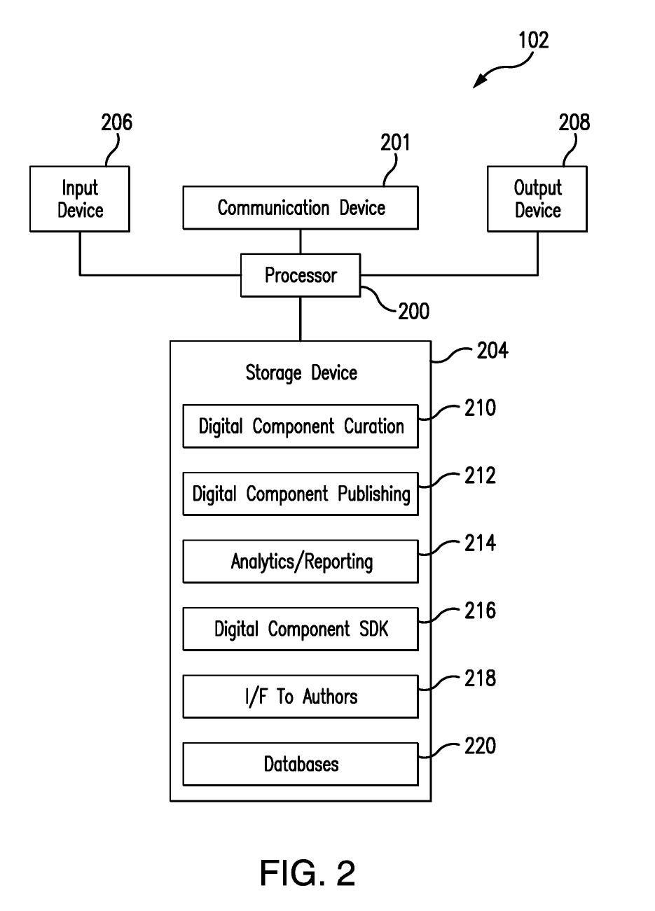

FIG. 2 is a block diagram of an example embodiment of the digital component management system 102 shown in FIG. 1.

In some embodiments, hardware aspects of the digital component management system 102 may be constituted by typical server computer and/or mainframe computer hardware, but may be controlled by software to cause it to function as described herein.

The digital component management system 102 may include a processor 200 operatively coupled to a communication device 201, a storage device 204, an input device 206 and an output device 208. The communication device 201, the storage device 204, the input device 206 and the output device 208 may all be in communication with the processor 200.

The processor 200 may be constituted by one or more processors. The processor 200 may operate to execute processor-executable steps, contained in program instructions described below, so as to control the digital component management system 102 to provide desired functionality.

Communication device 201 may be used to facilitate communication with, for example, other devices (such as authors' computing devices, and/or computers operated by digital delivery services). For example, communication device 201 may comprise numerous communication ports (not separately shown), to allow the digital component management system 102 to engage in data communication simultaneously with numerous other devices.

Input device 206 may comprise one or more of any type of peripheral device typically used to input data into a computer. For example, the input device 206 may include a keyboard and a mouse. Output device 208 may comprise, for example, a display and/or a printer.

Storage device 204 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 204 stores one or more programs for controlling processor 200. The programs comprise program instructions (which may be referred to as computer readable program code means) that contain processor-executable process steps of the digital component management system 102, executed by the processor 200 to cause the digital component management system 102 to function as described herein.

The programs may include one or more conventional operating systems (not shown) that control the processor 200 so as to manage and coordinate activities and sharing of resources in the digital component management system 102, and to serve as a host for application programs (described below) that run on the digital component management system 102.

The programs stored in the storage device 204 may also include digital component curation software 210. The digital component curation software 210 may control the processor 200 to support functionality of the digital component management system 102 in regard to the creation, receipt, storage, management, updating and maintenance of digital components such as those described herein. The functionality provided by the digital component curation software 210 may include allowing the author of the digital component to register events (e.g., fraud alerts) that are to be monitored with respect to the digital component.

The storage device 204 may also store digital component publishing software 212. The digital component publishing software 212 may control the processor 200 to permit the digital component management system 102 to provide functionality to handle all aspects of distributing and making available the digital components described herein for use by digital delivery services.

Further, the storage device 204 may store an analytics/reporting application program 214. The analytics/reporting application program 214 may control the processor 200 such that the digital component management system 102 performs analytical functions and provides reporting with respect to its own operations, including intake, management and distribution of digital components.

Still further, the storage device 204 may store a digital component software development kit (SDK) 216. The digital component SDK 216 may be available as a resource that is downloadable by digital component authors from the digital component management system 102 to aid the authors in their efforts to create new or modified digital components as described herein.

In addition, the storage device 204 may store a software interface 218 to support interactions between digital component authors and the digital component management system 102 for the purpose of submitting, updating, revising, releasing and/or certifying digital components.

The storage device 204 may also store, and the digital component management system 102 may also execute, other programs, which are not shown. For example, such other programs may also include, e.g., device drivers, database management programs, communications software, etc.

In some embodiments, the storage device 204 may also store one or more databases (reference numeral 220) required for operation of the digital component management system 102. For example, one or more databases may store digital components or pointers thereto to aid in storage, management and distribution of the digital components.

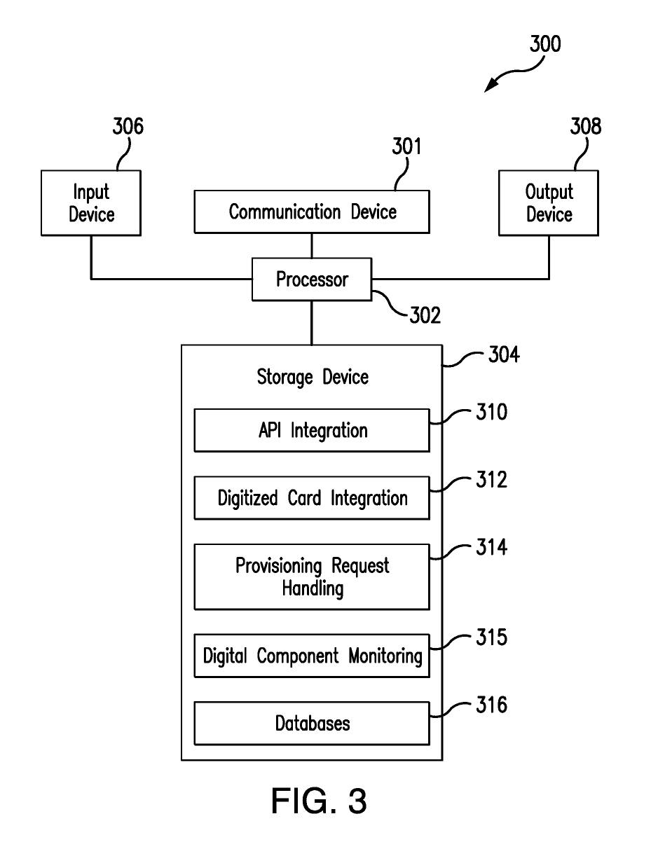

FIG. 3 is a block diagram illustration of a digital services computer 300 that may be an example embodiment of computer for performing digital delivery services as represented by block 104 in FIG. 1. The digital services computer 300 may be constituted by server computer and/or mainframe computer hardware.

The digital services computer 300 may include a computer processor 302 operatively coupled to a communication device 301, a storage device 304, an input device 306 and an output device 308. The computer processor 302 may be in communication with the communication device 301, the storage device 304, the input device 306 and the output device 308. The hardware architecture of the digital services computer 300 may resemble that of the digital component management system 102 as described above, and the above description of components of the digital component management system 102 may also apply to like-named components of the digital services computer 300.

Storage device 304 stores one or more programs for controlling processor 302. The programs comprise program instructions (which may be referred to as computer readable program code means) that contain processor-executable process steps of the digital services computer 300, executed by the processor 302 to cause the digital services computer 300 to function as described herein.

The programs stored by the storage device 304 may include one or more operating systems (not shown) that control the processor 302 so as to manage and coordinate activities and sharing of resources in the digital services computer 300, and to serve as a host for application programs that run on the digital services computer 300.

Further, the storage device 304 may store API integration software 310. The API integration software 310 may control the processor 302 such that suitable links are provided for API (application program interface) calls from other devices to interact effectively with services provided via the digital services computer 300.

The storage device 304 may also store a digitized card integration application program 312. The digitized card integration application program 312 may program the processor 302 to control the digital services computer 300 to perform functionality related to construction of digitized cards from adaptive digital components as described herein, while also utilizing other building blocks and/or other data relevant to the desired functioning of the digitized cards to be constructed.

The storage device 304 may also store a provisioning request handling application program 314. The provisioning request handling application program 314 may program the processor 302 to control the digital services computer 300 such that it is enabled to handle requests to provision digitized cards to digital card environments 106 (FIG. 1).

Continuing to refer to FIG. 3, the storage device 304 may additionally store a digital component monitoring program 315. The digital component monitoring program 315 may continuously monitor developments to detect events that have been registered as relevant to particular digital components that have been provisioned to card environments. Thus, there may be a cloud-based event management functionality, possibly provided by a payment system operator. When the digital component monitoring program 315 detects an event, the digital component monitoring program 315 may determine to which digital components the event is relevant, and may send an event notification to those components. It is to be understood, congruent with further discussion, that each digital component so notified is configured to respond appropriately to the event. Different components may be configured to respond differently to the same or similar events.

Continuing to refer to FIG. 3, the storage device 304 may further store database management programs and an internal reporting application (both not separately shown), the latter of which may respond to requests from computer system administrators for reports on the activities performed by the digital services computer 300; the storage device 304 may also store communication software, device drivers, etc.

The storage device 304 may also store one or more databases 316 required for operation of the digital services computer 300.

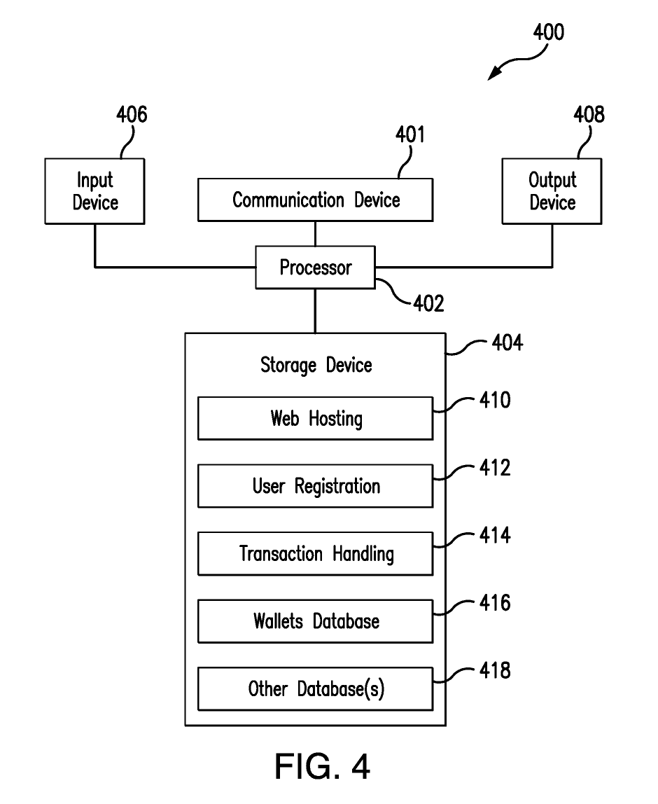

FIG. 4 is a block diagram illustration of an embodiment of a wallet service provider server computer 400 that is an example of one type of the digital card environments represented by block 106 in FIG. 1. The wallet service provider server computer 400 may, for example, be constituted by server computer hardware.

Continuing to refer to FIG. 4, the wallet service provider server computer 400 may include a computer processor 402 operatively coupled to a communication device 401, a storage device 404, an input device 406 and an output device 408. The computer processor 402 may be in communication with the communication device 401, the storage device 404, the input device 406 and the output device 408. The hardware architecture of the wallet service provider server computer 400 may resemble that of the digital component management system 102 as described above, and the above description of components of the digital component management system 102 may also apply to like-named components of the wallet service provider server computer 400.

Storage device 404 stores one or more programs for controlling processor 402. The programs comprise program instructions (which may be referred to as computer readable program code means) that contain processor-executable process steps of the wallet service provider server computer 400, executed by the processor 402 to cause the wallet service provider server computer 400 to function as described herein.

In many—if not most—respects, the functionality provided by the wallet service provider server computer 400 may resemble that of a typical WSP server. However, in accordance with teachings of the present disclosure, at least some of the digitized cards included in wallet partitions in the wallet service provider server computer 400 may incorporate adaptive digital components as described herein and accordingly may exhibit adaptive behavior or behaviors. Therefore, the wallet service provider server computer 400 may serve as an environment for digitized cards provided according to teachings of the present disclosure.

The programs stored by the storage device 404 may include one or more operating systems (not shown) that control the processor 402 so as to manage and coordinate activities and sharing of resources in the wallet service provider server computer 400, and to serve as a host for application programs that run on the wallet service provider server computer 400.

Further, the storage device 404 may store a web hosting application program 410. The web hosting application program 410 may control the processor 402 such that the wallet service provider server computer 400 is enabled to host a website to permit users/wallet holders to access the wallet service provider server computer 400.

In conjunction with the web hosting application program 410, the storage device 404 may also store a user registration application program 412. The user registration application program 412 may control the processor 420 to enable the wallet service provider server computer 400 to handle and process user registration requests and related inputs of data so that users can open user accounts to be maintained in the wallet service provider server computer 400.

The storage device 404 may further store a transaction handling application program 414 that programs the processor 402 to control the wallet service provider server computer 400 such that it is enabled to handle payment transactions, or other card access transactions utilizing digitized cards stored in the digital wallet partitions dedicated to individual registered users. As will be seen, in at least some cases, the transaction handling processes may feature adaptive behavior built into the digitized cards by incorporation therein of adaptive digital components as described herein

The storage device 404 may further store database management programs and an internal reporting application (both not separately shown), the latter of which may respond to requests from computer system administrators for reports on the activities performed by the wallet service provider server computer 400; the storage device 404 may also store communication software, device drivers, etc.

Moreover, the storage device 404 may store a wallets database 416. The wallets database 416 may hold digital wallet data partitions for respective individual users. One or more digitized cards issued (from various sources) to the users may be stored in each digital wallet data partition.

The storage device 404 may also store one or more other databases 418 required for operation of the wallet service provider server computer 400.

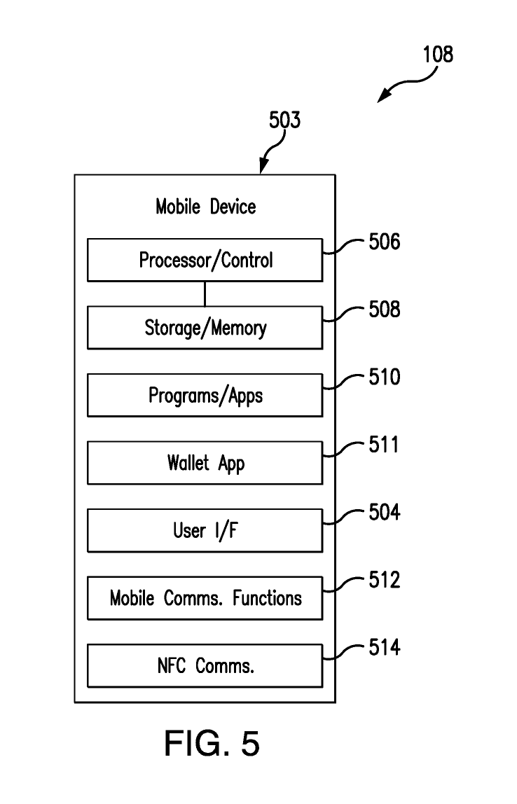

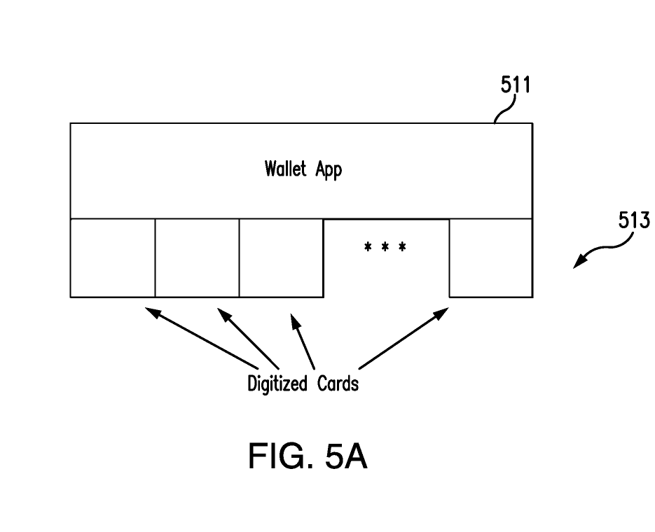

FIG. 5 is a simplified block diagram of a typical embodiment of the mobile device 108 that was depicted in FIG. 1. To some extent, it will be posited in the following discussion, without limitation, that the mobile device 108 is a smartphone.

The mobile device 108 may include a housing 503. In many embodiments, the front of the housing 503 is predominantly constituted by a touchscreen (not separately shown), which is a key element of the user interface 504 of the mobile device 108.

The mobile device 108 further includes a mobile processor/control circuit 506, which is contained within the housing 503. Also included in the mobile device 108 is a storage/memory device or devices (reference numeral 508). The storage/memory devices 508 are in communication with the processor/control circuit 506 and may contain program instructions to control the processor/control circuit 506 to manage and perform various functions of the mobile device 108. As is well-known, a smartphone may function as what is in effect a pocket-sized personal computer, via programming with a number of application programs, or “apps”, as well as a mobile operating system (OS). (The apps are represented at block 510 in FIG. 5, and may, along with other programs, in practice be stored in block 508, to program the processor/control circuit 506.)

Also shown in FIG. 5 is a wallet app 511. The wallet app 511 is shown apart from the other apps represented at block 510, in part due to the particular relevance of the wallet app 511 to the subject of this disclosure. In addition, the separate representation of the wallet app 511 also may be considered to represent the possibility that it is stored in a secured element (SE—not shown apart from block 511 or block 508), which may be provided in some embodiments of the mobile device 108 to provide enhanced security for the wallet app 511 and/or sensitive data associated therewith. The SE, if present, may be conventional in its hardware aspects. In addition or alternatively, security for the wallet app 511 may be enhanced by known alternatives to an SE, such as a TEE (trusted execution environment) and/or other security measures, environments or hardware aspects that serve to secure access to sensitive data and/or execution capabilities.

To the extent that the SE includes processing capabilities, it may functionally (though likely not physically) overlap with block 506; to the extent that the SE includes storage (and particularly program storage) capabilities, it may functionally (though likely not physically) overlap with block 508.

FIG. 5A is a schematic representation of some software aspects of the mobile device 108. Wallet app 511 is shown in FIG. 5A. Also shown are a number of digitized cards 513. The digitized cards 513 may be associated with the wallet app 511 such that the digitized cards 513 are accessible via the wallet app 511. At least some of the digitized cards 513 may incorporate adaptive components as described herein. In at least some cases the digitized cards 513 may be embodied as payment apps that have been personalized with user- and/or account-specific data. The wallet app 511 may be conventional in its operations or alternatively may have been configured to effectively support and enable adaptive features of the digitized cards 513.

As is typical for smartphones, the mobile device 108 may include mobile communications functions as represented by block 512. The mobile communications functions may include voice and data communications via a mobile communication network (not shown) with which the mobile device 108 is registered.

In addition, to facilitate use as a payment-enabled device, the mobile device 108 may include short-range radio communications capabilities (block 514), including for example NFC (near field communication). Thus block 514 may represent a suitable antenna (not separately shown) that is appropriate for NFC communications as well as driving and receiving circuitry associated with the antenna. It will be appreciated that the NFC antenna may be separate and different from the antenna (not separately shown) utilized by the mobile device 108 for the mobile communication functions represented by block 512. With the NFC capability, the wallet app and one or more digitized payment account cards, the mobile device 108 may be functional to be presented at a point of sale (not shown) to execute a purchase transaction via contactless transaction processing with the point of sale. For other purposes, other digitized cards 513 may enable the user 110 (FIG. 1) to employ the mobile device 108 to gain access to facilities (e.g., transit, or building/room entry) or to access privileges or provide identification represented by the digitized cards.

In accordance with known or proposed developments, payment capabilities of the mobile device 108 may extend to supporting remote e-commerce payments via web and/or “in-app”. Moreover, digitized cards (with adaptive features per teachings of the present disclosure) may be hosted in the cloud and accessed from the wallet app 511.

From the foregoing discussion, it will be appreciated that the blocks depicted in FIG. 5 as components of the mobile device 108 may in effect overlap with each other, and/or there may be functional connections among the blocks which are not explicitly shown in the drawing. It may also be assumed that, like a typical smartphone, the mobile device 108 may include a rechargeable battery (not shown) that is contained within the housing 503 and that provides electrical power to the active components of the mobile device 108.

Although the user device carried by the user 110 has been described herein primarily as a smartphone, in other embodiments, other types of mobile devices with similar capabilities may be used in place of a smartphone.

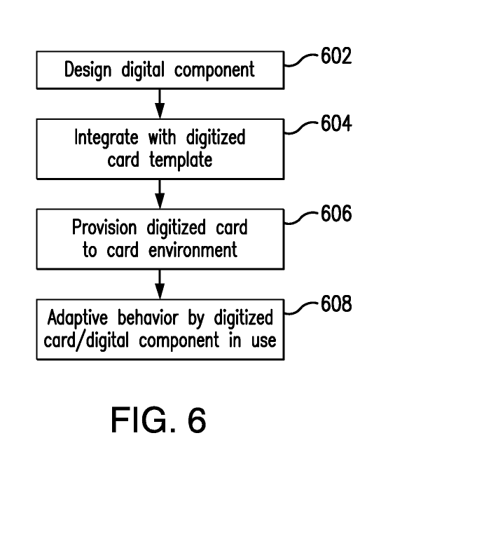

FIG. 6 is a flow chart that illustrates a process that may be performed in accordance with teachings of the present disclosure.

At 602, a digital component may be designed/authored. The digital component may be designed to exhibit adaptive behavior and/or to insert such behavior into a digitized card into which it is later incorporated. The digital component may be authored, for example, using the digital component SDK 216 referred to above in connection with FIG. 2. The digital component may be submitted to, stored in, and published by the digital component management system 102 (FIGS. 1 and 2).

Continuing to refer to FIG. 6, at block 604, the digital component referred to in connection with block 602 may be incorporated in a digitized card template. This may occur at a provider of digital delivery services, such as one represented by block 104 in FIG. 1. For example, the digital delivery service 104 may download the digital component and then may include the digital component in a digitized card template developed by the digital delivery service 104. In some embodiments, this process may include incorporation of an individual user's preferences, as communicated by the user to the digital component management system 102 and/or the digital delivery service 104.

Continuing to refer to FIG. 6, at block 606, the digital delivery service 104 may provision a digitized card, based on the digitized card template developed by the digital delivery service 104. The digitized card may have been personalized by including user- and/or account-specific data obtained by the digital delivery service from the issuer of the card/account. The digitized card may be provisioned to a digital card environment, such as a WSP server (FIG. 4; for inclusion in the card holder's digital wallet data partition in the WSP server) or to the card holder's mobile device 108 (for association with a wallet app 511).

Still referring to FIG. 6, at block 608, the provisioned digitized card may exhibit adaptive behavior while in use in the digital card environment to which it was provisioned. Examples of such adaptive behavior are provided below.

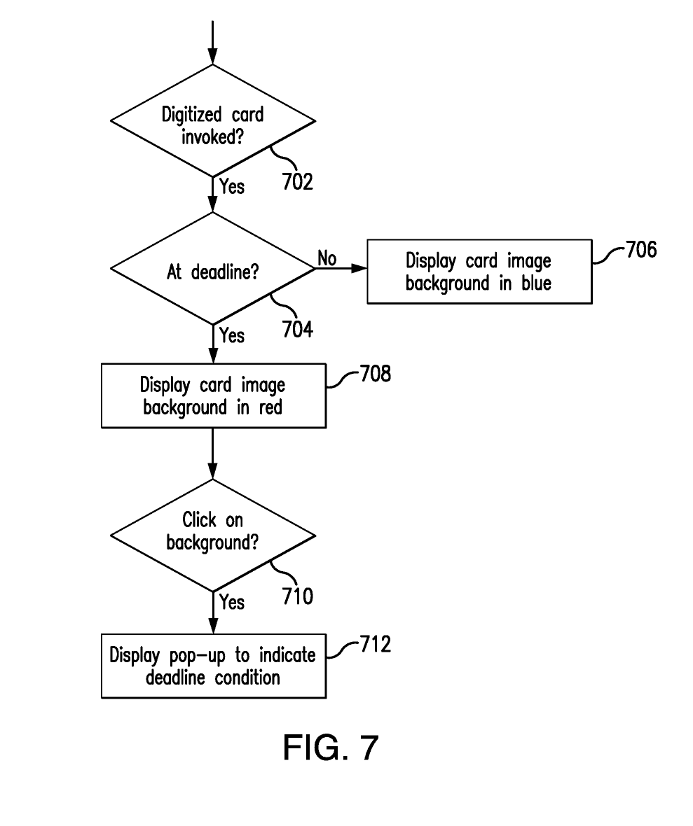

FIG. 7 is a flow chart that illustrates another process that may be performed in accordance with teachings of the present disclosure.

At decision block 702 in FIG. 7, it is determined whether the user 110 has invoked/requested access to a particular digitized card. For example, the user may have interacted with the wallet app 511 on his/her mobile device 108 to access a particular digitized card associated with the wallet app 511. (Alternatively, the user may have accessed the digitized card via the wallet data partition in a WSP computer in which the user's digital wallet is stored.)

If a positive determination is made at decision block 702, then decision block 704 may follow decision block 702. At decision block 704, it is determined whether a deadline condition exists for the digitized card in question. For example, if the digitized card is a library card, the deadline condition may be that a book that the user had checked out of the library is due to be returned. As another example, if the digitized card is a monthly-subscription unlimited-ride transit system access card, the deadline condition may be that the end of a calendar month is approaching and the user needs to engage in a transaction with the transit provider to renew the monthly subscription. As still another example, if the digitized card is a payment account card, the deadline condition may be that the monthly payment due date for the account is approaching without the monthly bill having yet been paid.

If a negative determination is made at decision block 704 (i.e., if no deadline condition exists), then block 706 may follow decision block 704. At block 706, the card background portion of the card image may be displayed in a color (say, blue) that is not indicative of any deadline condition being present.

If a positive determination is made at decision block 704 (i.e., if a deadline condition exists), then block 708 may follow decision block 704. At block 708, the card background portion of the card image may be displayed in a color (say, red) that is different from the color displayed if block 706 is reached, with the background color displayed at 708 being indicative that a deadline condition is present.

Decision block 710 may follow block 708 in the process of FIG. 7. At decision block 710, it may be determined whether the user has clicked/touched on the card background portion of the card image. If so, then block 712 may follow decision block 710. At block 712, the user's device (e.g., the mobile device 108, or another device by which the user may be accessing his/her remotely stored digital wallet) may display a pop-up image element or the like to inform the user of details of the current deadline condition. For example, the pop-up could display words such as “‘Of Mice and Men’ is due back at the library tomorrow”.

With a process like that shown in FIG. 7, the digitized card in question may exhibit adaptive behavior in that the manner in which the card image is displayed may vary depending on current conditions. The adaptive behavior may result from a corresponding adaptive digital component having been incorporated in the digitized card prior to the digitized card having been provisioned to the user's digital wallet.

It is to be understood that the change in card background color in the card image display is just one example of a number of different card display variations/adaptive behaviors that may be built into the digitized card via an adaptive digital component so that the digitized card may alert the user to a deadline condition. As will be seen, adaptive behaviors by the card image or elements thereof may be used to alert the user to other conditions besides deadline conditions.

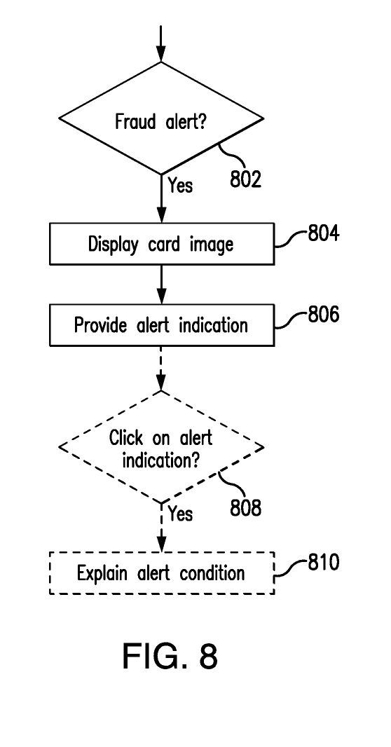

FIG. 8 is a flow chart that illustrates a process that may be performed in accordance with teachings of the present disclosure.

At decision block 802 in FIG. 8, it is determined whether a fraud alert has occurred for a payment account represented by a digitized card in the user's (mobile device or remotely stored) digital wallet. If so, block 804 may follow decision block 802. At block 804, the card image for the digitized card may be pushed for display on the user's device. (That is, the card image in question may be displayed even if the user has not invoked the digitized card in question and/or has not accessed the digital wallet. Alternatively, the card image may be displayed only if the user has invoked the digitized card.)

Block 806 may follow or accompany block 804. At block 806, an alert indication may be provided in conjunction with display of the card image.

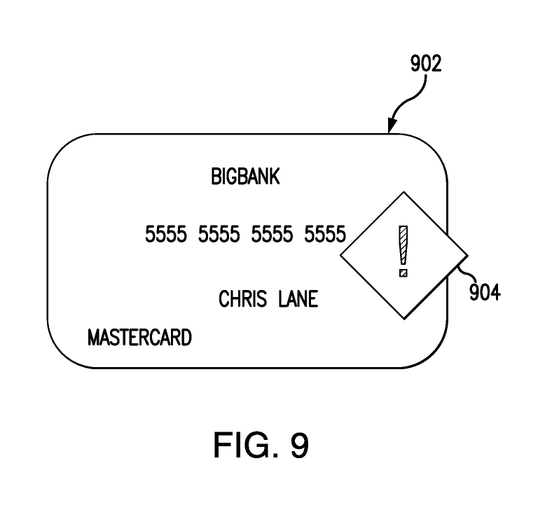

FIG. 9 is a schematic illustration of a card image 902 that may be presented to a user in connection with the process of FIG. 8. The alert indication may be a visual indication, as represented at 904 in FIG. 9. In addition or as an alternative to displaying the visual alert indication 904, the user device may provide an audible and/or vibratory alert indication to the user.

Referring again to FIG. 8, in some embodiments, further information may be provided to the user about the alert condition (fraud alert)—e.g.—if the user seeks such information. For example, as shown in phantom, a decision block 808 may follow block 806 in the process of FIG. 8. At decision block 808, it may be determined whether the user has clicked/touched on the alert indication 904 (FIG. 9). If so, and continuing to refer to FIG. 8, block 810 (shown in phantom) may follow decision block 808. At block 810, the user's device may download and/or display suitable information or details to describe the circumstances of the fraud alert to the user. In addition or alternatively, a link or phone number may be displayed to the user to allow the user to follow up/take action with respect to the fraud alert.

With a process such as that shown in FIG. 8, the digitized payment account card in question may exhibit adaptive behavior in that certain display and/or multimedia outputs are provided only under certain circumstance independent of any input or request made or provided by the user. The adaptive behavior may result from a corresponding adaptive digital component having been incorporated in the digitized payment account card prior to the digitized card having been provisioned to the user's digital wallet.

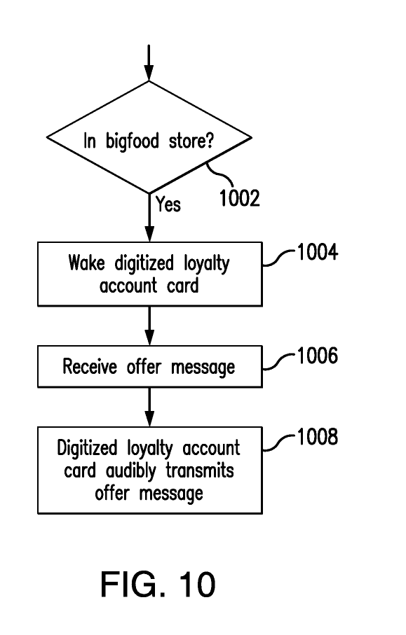

FIG. 10 is a flow chart that illustrates still another process that may be performed in accordance with teachings of the present disclosure.

At decision block 1002 in FIG. 10, the mobile device 108 may determine whether the user has brought the device onto the premises of a store in the (fictional) “BIGFOOD” supermarket chain. The determination may be made based on location system signals (e.g., GPS) or alternatively may reflect the device's detection of beacon/WiFi signals transmitted at the store location to announce by radio signal that the premises are a BIGFOOD location.

If a positive determination is made at decision block 1002, then block 1004 may follow decision block 1004. At block 1004, a digitized BIGFOOD customer loyalty account card—that has previously been provisioned to the mobile device 108—may be placed into an active condition (even though the user has taken no action to invoke the digitized loyalty account card).

Block 1006 may follow block 1004. At block 1006, the digitized loyalty account card may receive an offer message. For example, the above-mentioned radio beacon may broadcast a special offer (e.g., “Navel oranges on sale-5 for $4.00”). Alternatively, such a signal may be received by WiFi or via the mobile telecom provider for the mobile device 108—possibly with the digitized card inquiring via a mobile browser on the mobile device 108 via a query to the BIGFOOD consumer homepage about any special offers then in effect.

Block 1008 may follow block 1006. At block 1008, the digitized loyalty account card may cause the mobile device 108 to audibly transmit to the user 110 the offer message corresponding to the radio/mobile telecom message received at 1006.

With a process such as that shown in FIG. 10, the digitized customer loyalty account card may exhibit adaptive behavior in that it “wakes up” and delivers an offer message in response to a certain circumstance (i.e., the mobile device 108 being brought onto the store premises of the issuer of the digitized card), while refraining from such behavior under other circumstances. The adaptive behavior may result from a corresponding adaptive digital component having been incorporated in the digitized customer loyalty card prior to the digitized card having been provisioned to the user's mobile device 108.

One aspect of adaptive behavior by digitized cards/adaptive digital components, as described herein, is that the card/component produces one output under one set of circumstances or on one occasion, while producing a different output under another set of circumstances or on another occasion. Among the differing conditions that may result in different behavior is an indication that an account balance or an available credit balance is below a threshold amount.

The digitized cards described herein may be referred to as “data structures” notwithstanding that the same may include executable elements, scripts, widgets, and the like, as well as data.

As used herein and in the appended claims, the term “output” should be understood to refer to audible, visible, or vibratory signaling or other stimuli detectable by human senses, and may also refer to refraining from providing such output. In some embodiments, outputs of adaptive components may be limited to card images and associated image elements.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

The flow charts and descriptions thereof herein should not be understood to prescribe a fixed order of performing the method steps described therein. Rather the method steps may be performed in any order that is practicable, including simultaneous performance of steps.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” and “payment account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment card system” refers to a system for handling purchase transactions and related transactions. An example of such a system is the one operated by MasterCard International Incorporated, the assignee of the present disclosure. In some embodiments, the term “payment card system” may be limited to systems in which member financial institutions issue payment card accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
storing a digitized card data structure in association with a digital card environment, the digitized card data structure corresponding to a payment account card or other card issued to a card holder, the digitized card data structure having a component for providing output to the card holder;
determining, by the component, a first condition on a first occasion;
providing, by the component, a first output to the card holder on the first occasion in response to determining the first condition;
determining, by the component, a second condition on a second occasion, the second condition different from the first condition, the second occasion different from the first occasion; and
providing, by the component, a second output to the card holder on the second occasion in response to determining the second condition, the second output different from the first output.

2. The method of claim 1, wherein:
the first output is displaying a card image in a first color; and
the second output is displaying the card image in a second color different from the first color.

3. The method of claim 2, wherein:
the second condition indicates that a deadline has been reached.

4. The method of claim 2, wherein:
the second condition indicates that an account balance is below a threshold amount.

5. The method of claim 2, wherein:
the second condition indicates an available credit balance is below a threshold amount.

6. The method of claim 1, wherein the second condition indicates a fraud alert.

7. The method of claim 6, wherein the second output is a warning icon.

8. The method of claim 6, wherein the second output is a vibration signal.

9. The method of claim 1, wherein:
the digital card environment is stored in a mobile device;
the first condition is the mobile device being in a first location; and
the second condition is the mobile device being in a second location different from the first location.

10. The method of claim 1, wherein the digitized card data structure corresponds to a library card.

11. The method of claim 1, wherein the digitized card data structure corresponds to a transit system access card.

12. The method of claim 1, wherein the digitized card data structure corresponds to a customer loyalty account card.

13. The method of claim 1, wherein the second output is an audio output.

14. An apparatus comprising:
a processor; and
a memory device in communication with the processor, the memory device storing program instructions, the processor operative with the program instructions to perform functions as follows:
storing a digitized card data structure in association with a digital card environment, the digitized card data structure corresponding to a payment account card or other card issued to a card holder, the digitized card data structure having a component for providing output to the card holder;
determining, by the component, a first condition on a first occasion;
providing, by the component, a first output to the card holder on the first occasion in response to determining the first condition;
determining, by the component, a second condition on a second occasion, the second condition different from the first condition, the second occasion different from the first occasion; and
providing, by the component, a second output to the card holder on the second occasion in response to determining the second condition, the second output different from the first output.

15. The apparatus of claim 14, wherein:
the first output is displaying a card image in a first color; and
the second output is displaying the card image in a second color different from the first color.

16. The apparatus of claim 15, wherein:
the second condition indicates that a deadline has been reached.

17. The apparatus of claim 15, wherein:
the second condition indicates that an account balance is below a threshold amount.

18. A non-transitory memory device storing program instructions, the program instructions for controlling a processor to perform functions as follows:
storing a digitized card data structure in association with a digital card environment, the digitized card data structure corresponding to a payment account card or other card issued to a card holder, the digitized card data structure having a component for providing output to the card holder;
determining, by the component, a first condition on a first occasion;
providing, by the component, a first output to the card holder on the first occasion in response to determining the first condition;
determining, by the component, a second condition on a second occasion, the second condition different from the first condition, the second occasion different from the first occasion; and
providing, by the component, a second output to the card holder on the second occasion in response to determining the second condition, the second output different from the first output.

19. The memory device of claim 18, wherein:
the first output is displaying a card image in a first color; and
the second output is displaying the card image in a second color different from the first color.

20. The memory device of claim 19, wherein:
the second condition indicates that a deadline has been reached.
